(19) United States
(12) Patent Application Publication
(10) Pub. No.: US 2026/0129178 A1
(43) Pub. Date: May 7, 2026

(54) METHOD FOR DERIVING INTRA-PREDICTION MODE ON BASIS OF REFERENCE PIXEL

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Byeung Woo Jeon, Seongnam-si (KR); Bum Yoon Kim, Yongin-si (KR); Jee Hwan Lee, Gwacheon-si (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 18/864,161

(22) PCT Filed: Apr. 17, 2023
(86) PCT No.: PCT/KR2023/005157

§ 371 Date: Jul. 7, 2025

(30) Foreign Application Priority Data
May 12, 2022 (KR) 10-2022-0058185
Apr. 13, 2023 (KR) 10-2023-0048825

(51) Int. Cl. H04N 19/105; H04N 19/159; H04N 19/174; H04N 19/176; H04N 19/70

(52) U.S. Cl. CPC H04N 19/105; H04N 19/159; H04N 19/174; H04N 19/176; H04N 19/70

(57) ABSTRACT

A method and an apparatus are disclosed for video coding for deriving intra-prediction modes based on a reference pixel. In the disclosed embodiments, a video decoding device generates sub-pixel reference lines from integer-pixel reference lines. The video decoding device derives an implicit prediction mode by using the sub-pixel reference lines. Information for the implicit prediction mode includes a prediction direction and an upward prediction mode flag that indicates whether the prediction direction is upward. The video decoding device generates an intra-predictor of the current block by using the integer-pixel reference lines and the implicit prediction mode.

### TECHNICAL FIELD

The present disclosure relates to a method of deriving intra-prediction modes based on a reference pixel.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra prediction to predict pixel values of the current block to be encoded utilizes pixel information within the same picture. In intra prediction, of a plurality of intra-prediction modes, an appropriate one may be selected for the features of the video and used to predict the current block. The encoder selects and uses one of the many intra-prediction modes to encode the current block. The encoder may then pass information on that mode to the decoder.

HEVC technology utilizes a total of 35 intra-prediction modes for intra-prediction, including 33 angular modes that have directionality and two non-angular modes that have no directionality. However, as the spatial resolution of videos increases from 720×480 to 2048×1024 or 8192×4096, the unit size of the prediction block becomes larger and larger, which requires more intra-prediction mode varieties to be added. As illustrated in FIG. 3A, the VVC technique utilizes 67 prediction modes for intra-prediction, which are further subdivided for intra-prediction, allowing for a greater variety of prediction directions than in the prior art.

In general, the image to be encoded is partitioned into Coding Units (CUs) of various shapes and sizes and then encoded in CUs. In this case, a tree structure is the information that prescribes this partitioning. The encoder transfers the tree information to the decoder, dictating how the image is divided into CUs of different shapes and sizes. In that process, the luma (Y) and chroma (Cb, Cr) images may be split into separate CUs. Alternatively, the luma and chroma images can be split into CUs of the same shape.

A technique that provides the luma and chroma images with different partition structures is referred to as a chroma separate tree (CST) technique or dual tree technique. So, when the CST technique is used, the chroma image may be partitioned according to a different partitioning method than the luma image. On the other hand, a technique that provides the luma and chroma images with the same partition structure is called a single tree technique. When the single tree technique is used, the chroma image can have the same partition structure as the luma image. In the application of the CST technology, when setting the prediction mode of the luma channel and chroma channel the encoder performs a separate rate-distortion optimization (RDO) process. However, when doing the prediction mode setting of the Cb channel and Cr channel, the encoder performs the RDO process by applying the same prediction mode to both channels. When the encoder sets and encodes the intra-prediction modes according to the above, a lot of bit amount is used to encode the intra-prediction modes. Therefore, a method needs to be considered for efficiently encoding/decoding the intra-prediction modes to increase video coding efficiency and enhance video quality.

### DISCLOSURE

### Technical Problem

The present disclosure seeks to provide a video coding method and an apparatus that derive prediction modes of a luma channel and a chroma channel or generate a predictor, based on reference pixels without explicitly transmitting intra-prediction mode information in the intra-prediction of the current block.

### Technical Solution

At least one aspect of the present disclosure provides a method performed by a video decoding device for intra-predicting a current block. The method includes generating sub-pixel reference lines that include a top sub-pixel reference line and a left sub-pixel reference line from integer-pixel reference lines that belong to the current block and include a top integer-pixel reference line and a left integer-pixel reference line. The method also includes deriving an implicit prediction mode by using the sub-pixel reference lines. Here, information on the implicit prediction mode includes a prediction direction and an upward prediction mode flag that indicates whether the prediction direction is upward. The method also includes generating an intra-predictor of the current block by using the integer-pixel reference lines and the implicit prediction mode.

Another aspect of the present disclosure provides a method performed by a video encoding device for intra-predicting a current block. The method includes generating sub-pixel reference lines that include a top sub-pixel reference line and a left sub-pixel reference line from integer-pixel reference lines that belong to the current block and include a top integer-pixel reference line and a left integer-pixel reference line. The method also includes deriving an implicit prediction mode by using the sub-pixel reference lines. Here, information on the implicit prediction mode includes a prediction direction and an upward prediction mode flag that indicates whether the prediction direction is upward. The method also includes generating a first intra-predictor of the current block by using the integer-pixel reference lines and the implicit prediction mode.

Yet another aspect of the present disclosure provides a computer-readable recording medium storing a bitstream generated by a video encoding method. The video encoding method includes generating sub-pixel reference lines that include a top sub-pixel reference line and a left sub-pixel reference line from integer-pixel reference lines that belong to a current block and include a top integer-pixel reference line and a left integer-pixel reference line. The video encoding method also includes deriving an implicit prediction mode by using the sub-pixel reference lines. Here, information on the implicit prediction mode includes a prediction direction and an upward prediction mode flag that indicates whether the prediction direction is upward. The video encoding method also includes generating an intra-predictor of the current block by using the integer-pixel reference lines and the implicit prediction mode.

### Advantageous Effects

As described above, the present disclosure provides a video coding method and an apparatus that derive prediction modes of a luma channel and a chroma channel or generate a predictor, based on reference pixels without explicitly transmitting intra-prediction mode information in the intra-prediction of the current block. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram of pixels utilized in a Most Probable Mode (MPM) configuration.

FIG. 7 is a diagram illustrating reference lines of a Multiple Reference Line (MRL) technique.

FIG. 8 is a diagram illustrating the application of Derived Mode (DM) in a corresponding luma block.

FIG. 9 is a diagram illustrating a case where a prediction mode may be derived from reference pixels alone, according to at least one embodiment of the present disclosure.

FIG. 10 is a diagram illustrating an increase in the spacing between prediction modes for Wide Angle Intra Prediction (WAIP).

FIGS. 11A through 11C are diagrams illustrating the generation of a sub-pixel reference line, according to at least one embodiment of the present disclosure.

FIG. 12 is a diagram illustrating a case where edges are present on both the top reference line and the left reference line of the current block.

FIGS. 13A through 13B are diagrams illustrating the derivation of a prediction direction according to at least one embodiment of the present disclosure.

FIG. 14 is a diagram illustrating a limitation of a mapping value k, according to at least one embodiment of the present disclosure.

FIG. 15 is a diagram illustrating derived implicitAngle according to at least one embodiment of the present disclosure.

FIG. 16 is a flowchart of a method performed by a video encoding device for intra-predicting the current block, according to at least one embodiment of the present disclosure.

FIG. 17 is a flowchart of a method performed by a video decoding device for intra-predicting the current block, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

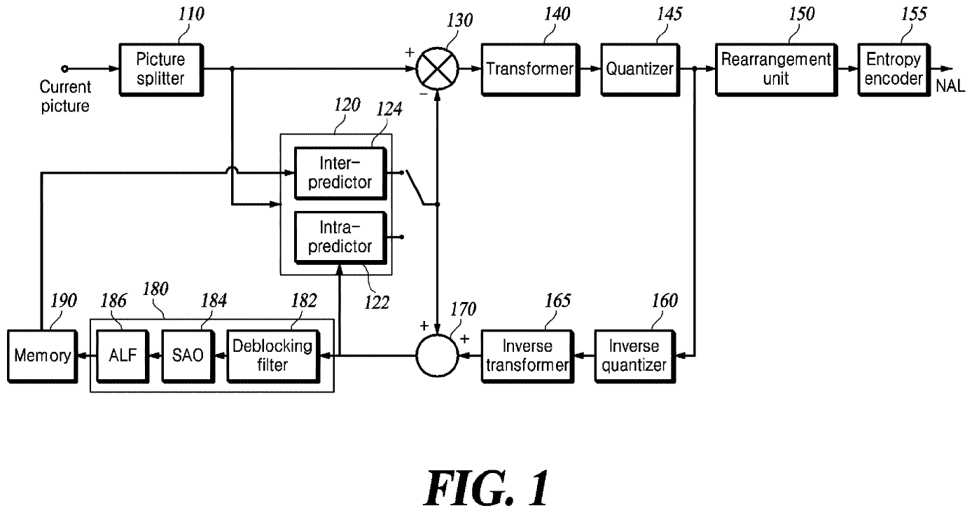

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

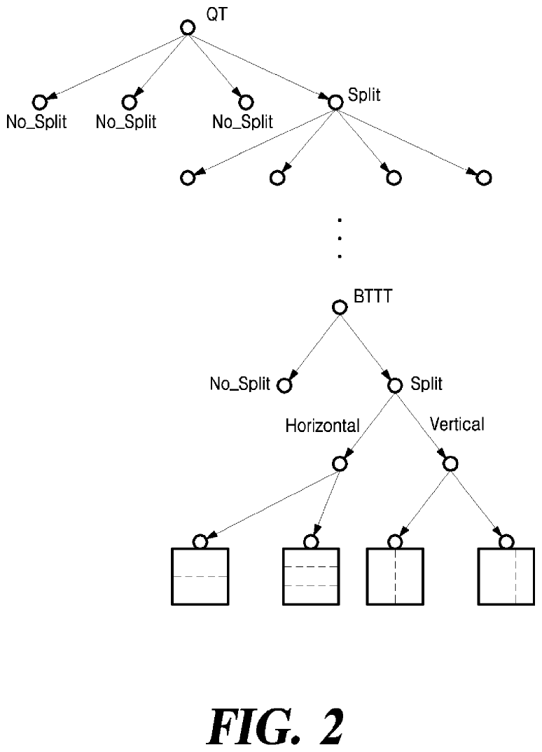

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus.

Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

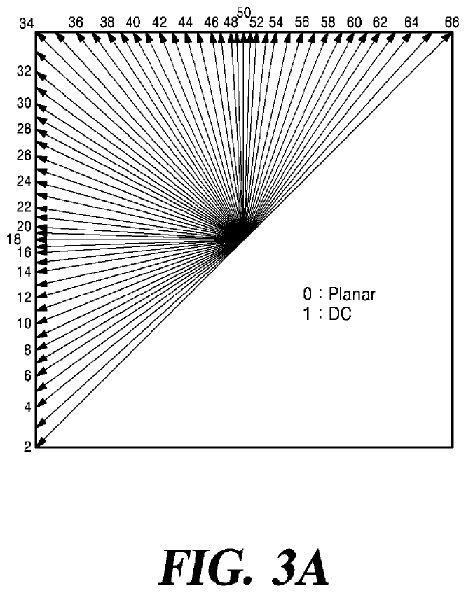

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

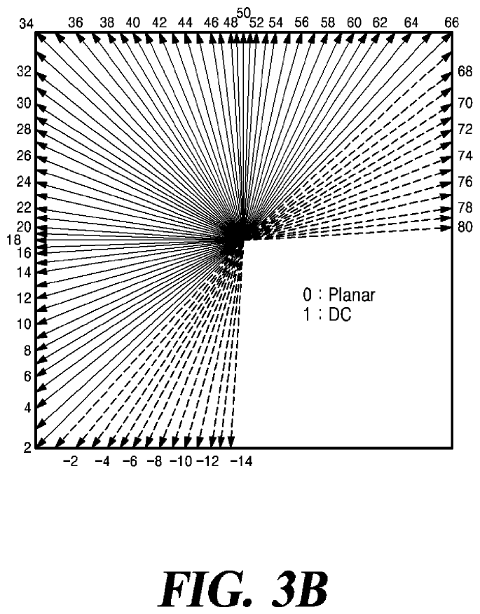

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

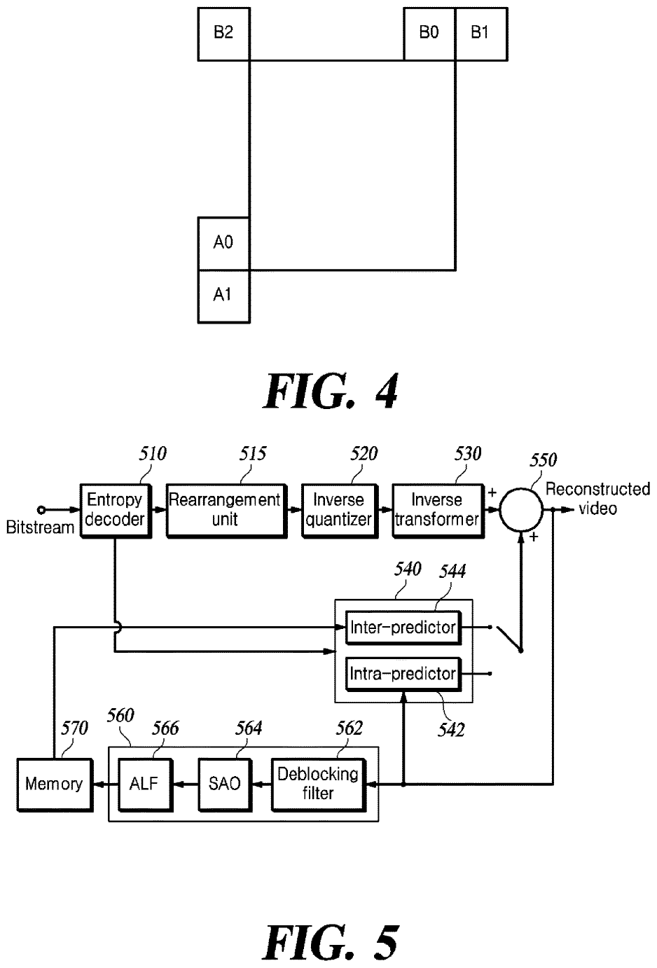

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and

extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that derive prediction modes of a luma channel and a chroma channel or generate a predictor, based on reference pixels, without explicitly transmitting intra-prediction mode information in the intra-prediction of the current block.

The following embodiments may be performed by the intra predictor 122 in the video encoding device. The following embodiments may also be performed by the intra predictor 542 in the video decoding device.

The video encoding device in the prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the prediction of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra-Prediction Techniques

The following describes prior art related to intra prediction.

### I-1. 67 Intra Prediction Modes (IPMs), Wide Angle Intra Prediction (WAIP)

The angular prediction directions used for intra prediction may be subdivided into up to 65 directions, as shown in the example of FIG. 3A. The prediction angle of the intra-prediction mode is represented by intraPredAngle, and the intraPredAngle values according to the prediction mode (predModeIntra) are shown in Table 1.

TABLE 1

| | predModeIntra | | | | | | | | | | | |
|---|---|---|---|---|---|---|---|---|---|---|---|---|
| | −14 | −13 | −12 | −11 | −10 | −9 | −8 | −7 | −6 | −5 | −4 | −3 |
| intraPredAngle | 512 | 341 | 256 | 171 | 128 | 102 | 86 | 73 | 64 | 57 | 51 | 45 |

| | predModeIntra | | | | | | | | | | | |
|---|---|---|---|---|---|---|---|---|---|---|---|---|
| | −2 | −1 | 2 | 3 | 4 | 5 | 6 | 7 | 8 | 9 | 10 | 11 |
| intraPredAngle | 39 | 35 | 32 | 29 | 26 | 23 | 20 | 18 | 16 | 14 | 12 | 10 |
| | predModeIntra | | | | | | | | | | | |
| | 12 | 13 | 14 | 15 | 16 | 17 | 18 | 19 | 20 | 21 | 22 | 23 |
| intraPredAngle | 8 | 6 | 4 | 3 | 2 | 1 | 0 | −1 | −2 | −3 | −4 | −6 |

| | predModeIntra | | | | | | | | | | | |
|---|---|---|---|---|---|---|---|---|---|---|---|---|
| | 24 | 25 | 26 | 27 | 28 | 29 | 30 | 31 | 32 | 33 | 34 | 35 |
| intraPredAngle | −8 | −10 | −12 | −14 | −16 | −18 | −20 | −23 | −26 | −29 | −32 | −29 |

| | predModeIntra | | | | | | | | | | | |
|---|---|---|---|---|---|---|---|---|---|---|---|---|
| | 36 | 37 | 38 | 39 | 40 | 41 | 42 | 43 | 44 | 45 | 46 | 47 |
| intraPredAngle | −26 | −23 | −20 | −18 | −16 | −14 | −12 | −10 | −8 | −6 | −4 | −3 |

| | predModeIntra | | | | | | | | | | | |
|---|---|---|---|---|---|---|---|---|---|---|---|---|
| | 48 | 49 | 50 | 51 | 52 | 53 | 54 | 55 | 56 | 57 | 58 | 59 |
| intraPredAngle | −2 | −1 | 0 | 1 | 2 | 3 | 4 | 6 | 8 | 10 | 12 | 14 |
| | predModeIntra | | | | | | | | | | | |
| | 60 | 61 | 62 | 63 | 64 | 65 | 66 | 67 | 68 | 69 | 70 | 71 |
| intraPredAngle | 16 | 18 | 20 | 23 | 26 | 29 | 32 | 35 | 39 | 45 | 51 | 57 |

| | predModeIntra | | | | | | | | |
|---|---|---|---|---|---|---|---|---|---|
| | 72 | 73 | 74 | 75 | 76 | 77 | 78 | 79 | 80 |
| intraPredAngle | 64 | 73 | 86 | 102 | 128 | 171 | 256 | 341 | 512 |

With the introduction of WAIP, prediction modes of Nos. −14 to −1 and 67 to 80 with larger angles may be used depending on the aspect ratio of the block.

In intra prediction, a predictor for the luma channel may be generated based on 67 intra-prediction modes (IPMs). 67 IPMs means 67 intra-prediction modes that can be signaled based on the aspect ratio of the block among prediction modes −14 through 80, including planar and DC modes which are non-directional prediction modes.

### I-2. Matrix-Based Intra Prediction (MIP)

The MIP mode uses the product of a trained matrix and a reference sample to generate a predictor for the current block. The MIP mode uses three steps to generate the predictor. First, a one-dimensional vector is generated by using the average of the reference samples. Second, a predictor is generated by using the product of the trained matrix and the one-dimensional vector. Finally, third, if a portion of the predictor was generated in the second step, further interpolation is performed to upsample or upscale the predictor portion to fit the size of the current block.

To indicate whether such an MIP is enabled, the video encoding device may encode and then transmit a matrix-based prediction flag to the video decoding device. Further, the video encoding device may encode and then transmit to the video decoding device an index indicative of one of the trained matrices and one of the predefined vectors.

### I-3. Most Probable Mode (MPM)

When a predictor is generated by using one of the 67 prediction modes, the video encoding device may signal the prediction mode by using the Most Probable Mode (MPM) to efficiently transmit the prediction mode information.

MPM takes advantage of the property that when blocks are encoded in intra-prediction mode, the prediction modes of neighboring blocks are likely to be similar to each other. Based on the prediction modes of the neighboring blocks of the current block, 6 MPM candidates are selected. The set of 6 MPM candidates is called the MPM list. If the intra-prediction mode of the current block is included in the MPM list, the video encoding device signals the MPM index that indicates the intra-prediction mode of the current block among the candidates included in the MPM list. On the other hand, if the intra-prediction mode of the current block is not included in the 6 MPM candidates, the video encoding device composes an MPM remainder by excluding the 6 MPM candidates out of the 67 IPMs and encodes the intra-prediction mode based on the MPM remainder.

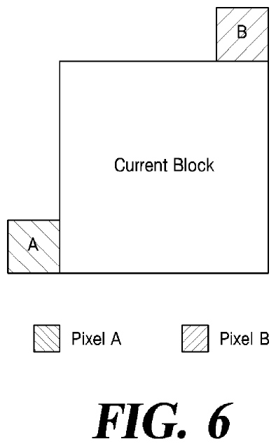

As shown in the example of FIG. 6, defined as modeA is the prediction mode of the block containing pixel A located to the left of the bottom-left pixel of the current block, and defined as modeB is the prediction mode of the block containing pixel B located above the top-right pixel of the current block. Based on modeA and modeB, 6 MPM candidates may be selected to generate an MPM list as follows. If the current block is located at the boundary of a CTU, tile, slice, sub-picture, picture, and the like and pixel A or pixel B is not available, the prediction mode of the block containing the pixel is considered to be planar.

First, if modeA and modeB are the same and modeA is greater than INTRA_DC, selected as MPM candidates are {Planar, modeA, 2+((modeA+61) % 64), 2+((modeA−1) % 64), 2+((modeA+60) % 64), 2+(modeA % 64)}.

Next, if modeA and modeB are not the same, and either modeA or modeB is greater than INTRA_DC, the MPM candidates are composed as follows. Here, minAB=Min (modeA, modeB), maxAB=Max (modeA, modeB).

If both modeA and modeB are greater than INTRA_DC and maxAB−minAB=1, then selected as MPM candidates are {Planar, modeA, modeB, 2+((minAB+61) % 64), 2+((maxAB−1) % 64), 2+((minAB+60) % 64)}.

If both modeA and modeB are greater than INTRA_DC and maxAB−minAB≥62, selected as MPM candidates are {Planar, modeA, modeB, 2+((minAB−1) % 64), 2+((maxAB+61) % 64), 2+(minAB % 64)}.

If both modeA and modeB are greater than INTRA_DC and maxAB−minAB=2, selected as MPM candidates are {Planar, modeA, modeB, 2+((minAB−1) % 64), 2+((minAB+61) % 64), 2+((maxAB−1) % 64)}.

If both modeA and modeB are greater than INTRA_DC and 2<maxAB−minAB<62, selected as MPM candidates are {Planar, modeA, modeB, 2+((minAB+61) % 64), 2+((minAB−1) % 64), 2+((maxAB+61) % 64)}.

If modeA and modeB are not the same, and one of modeA and modeB is greater than INTRA_DC, selected as MPM candidates are {Planar, maxAB, 2+((maxAB+61) % 64), 2+((maxAB−1) % 64), 2+((maxAB+60) % 64), 2+(maxAB % 64)}.

Further, if both modeA and modeB are equal to or less than INTRA_DC, selected as MPM candidates are {Planar, INTRA_DC, INTRA_ANGULAR50, INTRA_ANGULAR18, INTRA_ANGULAR46, INTRA_ANGULAR54}.

### I-4. Intra Sub-Partition (ISP)

The ISP technique sub-partitions the current block into smaller blocks of the same size and then shares the intra-prediction mode across the subblocks, but the ISP may apply the transform to each subblock. The sub-partition of the block may be horizontally or vertically oriented.

In the following description, the large block before being sub-partitioned is referred to as the current block, and each of the sub-partitioned smaller blocks is referred to as a subblock.

The operation of the ISP technology is as follows.

The video encoding device signals to the video decoding device the intra_subpartitions_mode_flag, which indicates whether ISP is to be applied, and the intra_subpartitions_split_flag, which indicates a method of sub-partitioning. The sub-partition types, IntraSubPartitionsSplitType according to intra_subpartitions_mode_flag and intra_subpartitions_split_flag are shown in Table 2.

TABLE 2

| IntraSubPartitionsSplitType | Name of IntraSubPartitionsSplitType |
|---|---|
| 0 | ISP_NO_SPLIT |
| 1 | ISP_HOR_SPLIT |
| 2 | ISP_VER_SPLIT |

The ISP technology sets the partition types, IntraSubPartitionsSplitType as follows.

If intra_subpartitions_mode_flag is 0, IntraSubPartitionsSplitType is set to 0 and no subblock partitioning is performed. Namely, no ISP is applied.

If intra_subpartitions_mode_flag is non-zero, ISP is applied. In this case, IntraSubPartitionsSplitType is set to the value of 1+intra_subpartitions_split_flag, and subblock partitioning is performed according to the partition type. If IntraSubPartitionsSplitType=1, a subblock partition (ISP_HOR_SPLIT) is performed in the horizontal direction, and if IntraSubPartitionsSplitType=2, a subblock partition (ISP_VER_SPLIT) is performed in the vertical direction. This means that the intra_subpartitions_split_flag may indicate the subblock partition direction.

For example, if the ISP mode of horizontal sub-partitioning is applied to the current block, IntraSubPartitionsSplitType is 1, intra_subpartitions_mode_flag is 1, and intra_subpartitions_split_flag is 0.

In the following description, intra_subpartitions_mode_flag is expressed as a subblock partition application flag, intra_subpartitions_split_flag is expressed as a subblock partition direction flag, and IntraSubPartitionsSplitType is expressed as a subblock partition type. Further, the information including the subblock partition application flag and the subblock partition direction flag is referred to as ISP information.

As described above, when the current block is sub-partitioned in the horizontal or vertical direction, if the size of the current block is too small, the coding efficiency of the partitioned subblocks may be unexpectedly reduced, or the smaller size of the subblocks than the minimum unit for transform may disallow the transform in the first place. To prevent this from happening, the application of ISP may be restricted by reference to the size of the subblock obtained after partitioning. For example, if the number of pixels in the partitioned subblock is greater than 16, sub-partition may be applied. For example, if the current block is 4×4 in size, ISP is not applied. A block with a size of 4×8 or 8×4 may be partitioned into two subblocks of the same shape and size, which is called a Half_Split. A block of any other size may be partitioned into four subblocks of the same shape and size, called a Quarter_Split.

The video encoding device encodes the respective subblocks sequentially. In this case, each subblock shares the same intra-prediction information. In the intra prediction for encoding the respective subblocks, the video encoding device may utilize the reconstructed pixels in the earlier encoded subblock as the predicted pixel values for the subsequent subblocks, thereby increasing the compression efficiency.

### I-5. Multiple Reference Line (MRL)

MRL (Multiple Reference Line) technology when the current block is predicted according to the intra-prediction technology may use reference lines adjacent to the current block as well as pixels further away as reference pixels. At this time, pixels with the same distance from the current block are grouped together and named as a reference line. The MRL technique performs intra prediction of the current block by using the pixels located on the selected reference line.

To indicate the reference line to use when the intra prediction is performed, the video encoding device signals the reference line index intra_luma_ref_idx to the video decoding device. The bit allocation for each index may be represented as shown in Table 3.

TABLE 3

| intra_luma_ref_idx | Bit allocation |
|---|---|
| 0 | 0 |
| 1 | 10 |
| 2 | 11 |

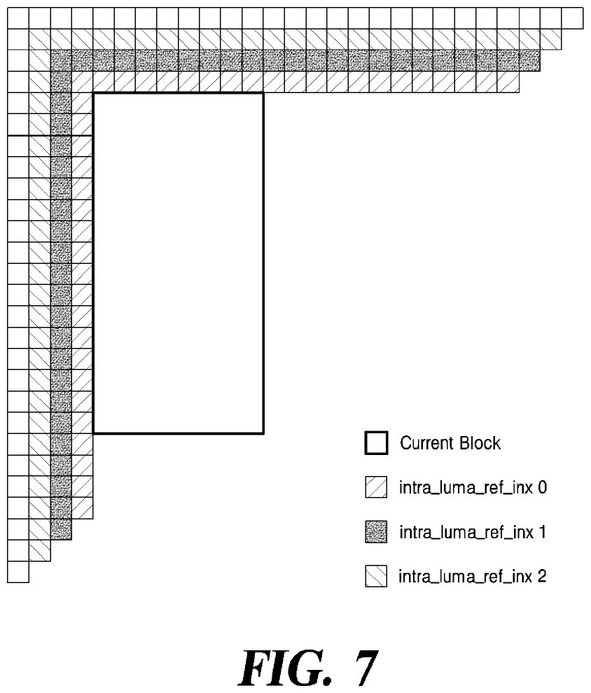

The video encoding device may consider whether to use additional reference lines by applying the MRL for prediction modes that are signaled according to the MPM, except the planar mode among the intra-prediction modes. The reference line represented by each intra_luma_ref_idx is as shown in the example in FIG. 7. In the VVC (Versatile Video Coding) technique, the video encoding device selects one of the three reference lines that is closer in distance to the current block to be used for the intra prediction of the current block.

### I-6 Derived Mode (DM)

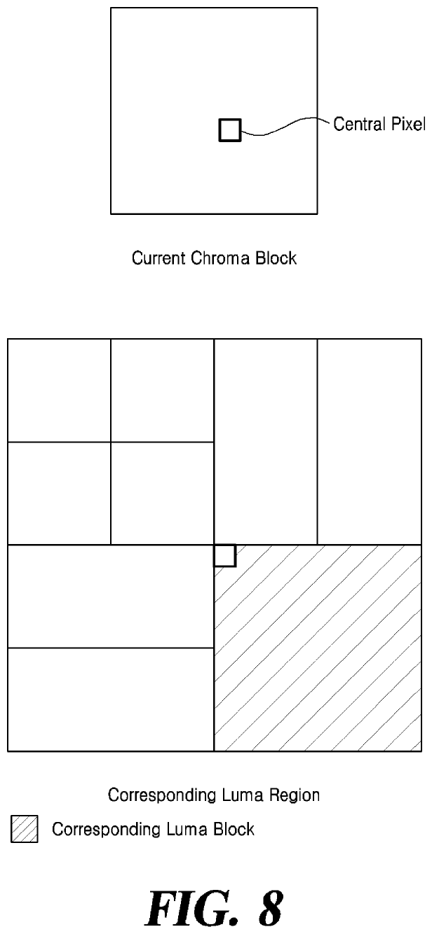

DM, which is introduced for efficient encoding/decoding of the prediction mode of the chroma channel, uses the prediction mode of the luma block corresponding to the current chroma block as it is as the prediction mode of the chroma block. In this case, the corresponding luma block represents a luma block containing the luma channel's pixel corresponding to the pixel at the center position of the current chroma block, as shown in the example of FIG. 8.

As described above, many prediction techniques are utilized to increase intra-coding efficiency for the luma channel, but the application of different prediction techniques is subject to the following limitations.

For the application of ISP mode, intra_luma_ref_idx needs to be zero.

intra_luma_ref_idx may have a non-zero value only if the prediction mode is included in the MPM list.

If the prediction mode is planar, intra_luma_ref_idx cannot have a non-zero value.

To apply different intra-prediction techniques considering the above-described restrictions, the syntax of the intra-prediction mode of the luma channel may be represented as shown in Table 4.

```
TABLE 4
if( sps_mip_enabled_flag )
    intra_mip_flag
if( intra_mip_flag ) {
    intra_mip_transposed_flag[ x0 ][ y0 ]
    intra_mip_mode[ x0 ][ y0 ]
} else {
    if( sps_mrl_enabled_flag && ( ( y0 % CtbSizeY ) > 0 ) )
      intra_luma_ref_idx
  if( sps_isp_enabled_flag && intra_luma_ref_idx = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
      intra_subpartitions_mode_flag
    if( intra_subpartitions_mode_flag = = 1 )
    intra_subpartitions_split_flag
    if( intra_luma_ref_idx = = 0 )
    intra_luma_mpm_flag[ x0 ][ y0 ]
    if( intra_luma_mpm_flag[ x0 ][ y0 ] ) {
    if( intra_luma_ref_idx = = 0 )
        intra_luma_not_planar_flag[ x0 ][ y0 ]
    if( intra_luma_not_planar_flag[ x0 ][ y0 ] )
        intra_luma_mpm_idx[ x0 ][ y0 ]
    } else
    intra_luma_mpm_remainder[ x0 ][ y0 ]
}
```

First, the video decoding device parses intra_mip_flag which is a flag indicating whether the prediction mode is MIP mode. If the prediction mode is MIP mode and intra_mip_flag is true, the video decoding device decodes intra_mip_transposed_flag and intra_mip_mode. The intra_mip_transposed_flag indicates whether the matrix used to generate the predictors in MIP mode is transposed, and the intra_mip_mode indicates the type of matrix. If intra_mip_flag is false because MIP mode is not used, the video decoding device parses the MRL and ISP mode information in order according to the conditions. The video decoding device then decodes the intra_luma_mpm_flag which indicates whether the prediction mode is included in the MPM list. By decoding intra_luma_mpm_idx or intra_luma_mpm_remainder depending on the intra_luma_mpm_flag, the video decoding device completes the decoding of the intra-prediction mode.

Regarding the chroma channel, the video decoding device may generate a predictor by using three Cross Component Linear Model (CCLM) modes, planar, DC, horizontal mode, vertical mode, and Derived Mode (DM). The predictor may be generated by using subdivided prediction modes based on DM for the chroma channel, with the limitation of using only the prediction mode that the corresponding luma block uses. In other words, the luma channel allows to search for the optimal prediction mode based on 67 IPMs in determining the prediction mode, but the chroma channel disallows to search for all 67 IPMs, but only for five prediction modes (planar, DC, horizontal, vertical, and DM).

According to the prior art, when the MPM list has the components of {0, 1, 50, 18, 46, 54}, the encoding of 67 IPMs (intra-prediction modes) is performed as shown in Table 5.

TABLE 5

| Mode | Bin string |
|---|---|
| 0 | 10 |
| 1 | 110 |
| 2 | 000000 |
| 3 | 000001 |
| 4 | 000010 |
| . . . | . . . |
| 17 | 0010010 |
| 18 | 11110 |
| 19 | 0010011 |
| 20 | 0010100 |
| . . . | . . . |
| 45 | 0101101 |
| 46 | 111110 |
| 47 | 0101110 |
| . . . | . . . |
| 49 | 0110000 |
| 50 | 1110 |
| 51 | 0110001 |
| 52 | 0110010 |
| 53 | 0110011 |
| 54 | 111111 |
| 55 | 0110100 |
| 56 | 0110101 |
| 57 | 0110110 |
| 58 | 0110111 |
| 59 | 0111000 |
| 60 | 0111001 |
| 61 | 0111010 |
| 62 | 0111011 |
| 63 | 0111100 |
| 64 | 0111101 |
| 65 | 0111110 |
| 66 | 0111111 |

Here, the bin string does not contain intra_mip_flag, intra_luma_ref_idx, and intra_subpartitions_mode_flag. The first bin of the bin string represents the intra_luma_mpm_flag. For example, if the prediction mode of the luma channel is planar and no ISP (Intra Sub-Partition) is applied, the bin string representing the intra-prediction mode of the luma channel is signaled as 00010. On the other hand, if the prediction mode of the luma channel is not included in the MPM list, the bin string may be longer. For example, if the prediction mode is 60 and the ISP of the horizontal partition is applied, the bin string for the prediction mode is 00100111001, where a bin string of length 11 is signaled.

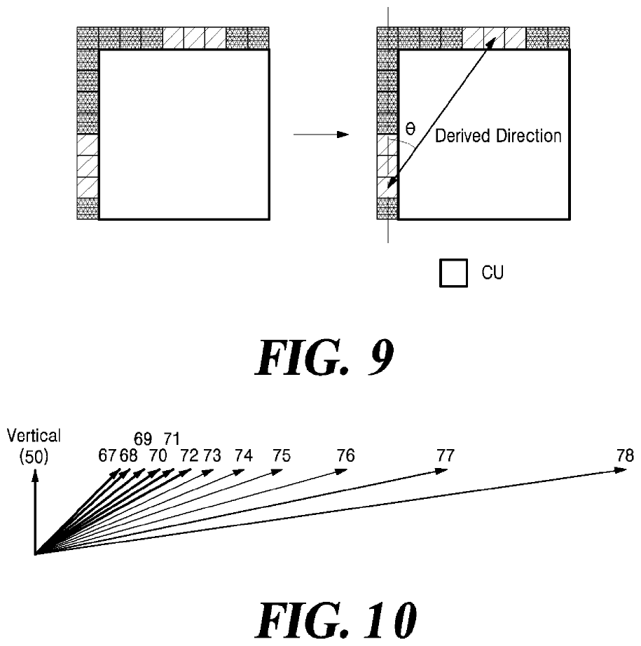

Although there are cases such as the example in FIG. 9 where a prediction mode may be derived by using only reference pixels, the prior art has a deficiency in that the length of the bin string is 11 for the prediction mode illustrated in FIG. 9.

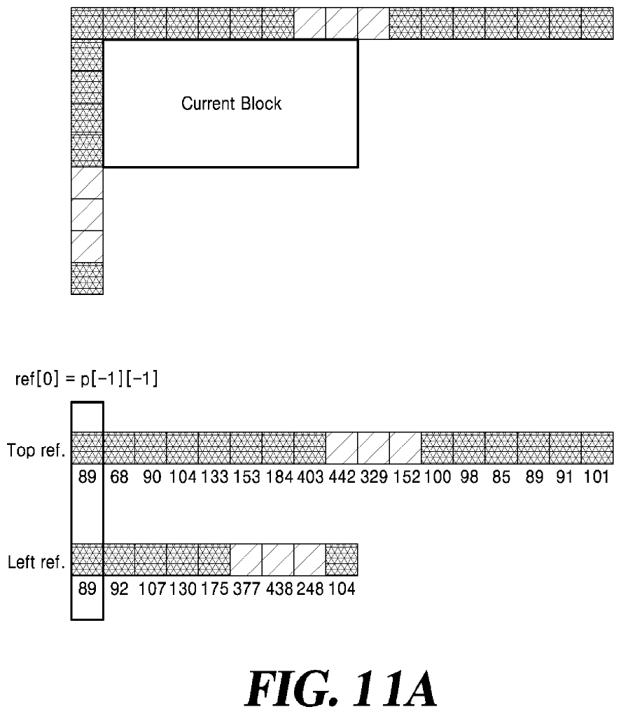

Furthermore, in the case of WAIP (wide angle intra prediction), as the value of intraPredAngle increases, the spacing between the prediction modes that dictate intraPredAngle increases, as shown in the example of FIG. 10. Accordingly, the precision of the prediction mode decreases, and the greater the block size, the worse the decrease may be in precision.

As described above, the optimal prediction mode may be determined after searching only five prediction modes out of 67 IPMs for the chroma channel. In the case of directional modes, only 3 modes out of 65 directional modes are searched. Namely, a limitation exists that the number of prediction modes of the chroma channel is very small compared to the luma channel.

Hereinafter, embodiments of the present disclosure will be described centered on the video decoding device, but the embodiments may be similarly applied to the video encoding device.

### II. Implementations According to the Present Disclosure

To solve the matters described above, the present disclosure derives a prediction direction based on reference samples, as illustrated in FIG. 9. Thus, the present disclosure can increase the efficiency of intra-coding by not transmitting prediction mode information, performing prediction in a direction that cannot be directed by prediction mode, or minimizing the length of the bin string for prediction mode information.

To realize the present disclosure, the derivation of a prediction direction based on reference samples includes two steps: obtaining a sub-pixel reference line and deriving a prediction direction.

The step of obtaining the sub-pixel reference line is described below.

The top reference line represents an array of referenceable pixels that are above the top-left pixel of the current block. The left reference line indicates an array of referenceable pixels that are to the left of the top-left pixel of the current block. The video decoding device may derive the prediction direction by using the top reference line and the left reference line as they are, but it is very difficult to derive the prediction direction exactly, and the derived prediction direction is not precise. Therefore, to achieve a precise and accurate derivation of the prediction direction, the video decoding device upscales each reference line to obtain a sub-pixel reference line. The upscaling factor indicates the percentage of the sub-pixel that is enlarged after performing the upscaling. For example, when the upscaling factor is 4, the resolution of the sub-pixel becomes ¼ pel.

The interpolation filter used to perform the upscaling and the upscaling factor may vary depending on the implementation of the present disclosure. The interpolation filter used may be a nearest filter, a linear filter, a cubic filter, a sinc filter, a gaussian filter, or the like, and the upscaling factor used may be 2, 3, 4, or the like.

Hereinafter, the width of the block is defined as W and the height as H. When the top reference line has a length of 2W+1 and the left reference line has a length of 2H+1, and the upscaling factor is u, the lengths of the sub-pixel reference lines are 2Wu+1 for the top and 2Hu+1 for the left.

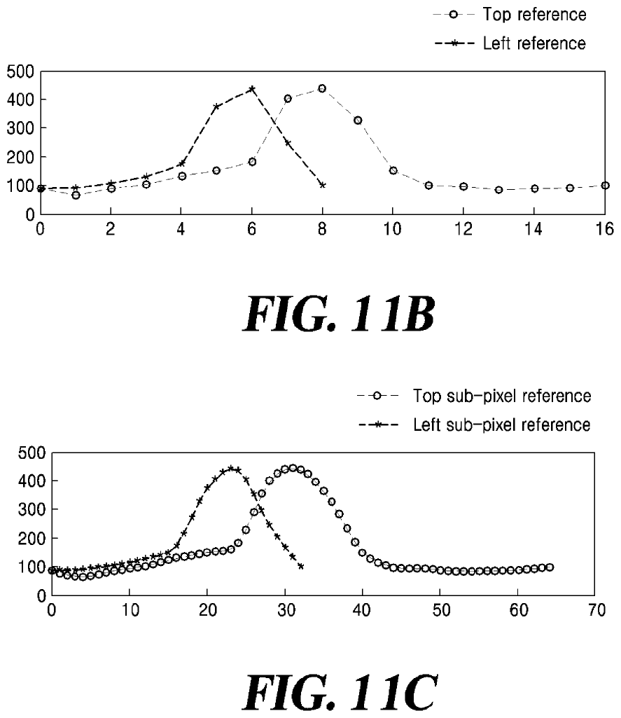

FIGS. 11A through 11C are diagrams illustrating the generation of sub-pixel reference lines according to at least one embodiment of the present disclosure.

As shown in the examples of FIGS. 11A to 11C, when W=8, H=4, sub-pixel reference lines may be obtained by using a cubic interpolation filter with u=4 (i.e., ¼ pel resolution). The values of the reference samples as illustrated in FIG. 11A may be graphed as shown in the example of FIG. 11B. In the example of FIG. 11B, the horizontal axis indicates the positions of the reference samples and the vertical axis indicates the values of the reference samples. The example of FIG. 11C is a graph representing generated sub-pixel reference lines. The sub-pixel reference lines are represented by SPRL_{T}[x] indicating the top sub-pixel reference line and SPRL_{L}[x] indicating the left sub-pixel reference line. In the top sub-pixel reference line, x has a value from 0 to 64, and in the left sub-pixel reference line, x has a value from 0 to 32. SPRL_{T}[0] and SPRL_{L}[0] are the reference pixels at position (−1, −1) when the top-left pixel of the current block is positioned at (0,0).

Next, the step of deriving the prediction direction is described below.

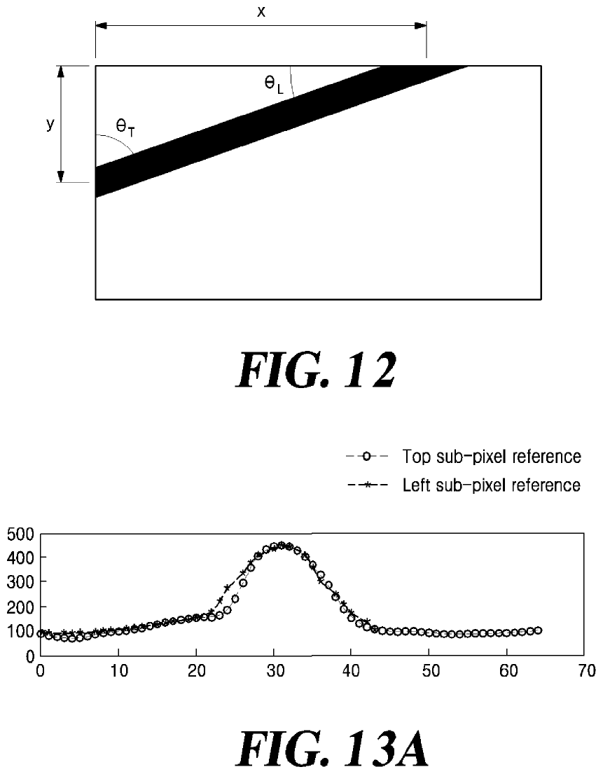

If edges exist on both the top reference line and the left reference line of the current block, the current block is highly probable to be an image containing a straight line passing through two boundaries, as shown in the example of FIG. 12. In such a case, the direction of the straight line passing through the two boundaries is determined as the prediction direction.

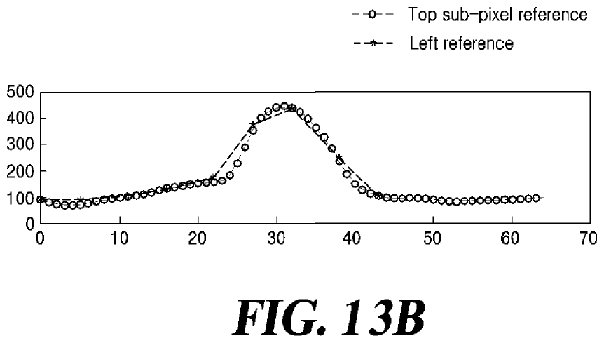

On the other hand, after either of the two sub-pixel reference lines of FIG. 11C is mapped, the one mapped reference line may be approximated to the other sub-pixel reference line as shown in the example of FIG. 13A. At this time, by finding a mapping value k that minimizes the difference between the two sub-pixel reference lines, the video decoding device may derive a prediction direction. The value k found is equal to the tangent value (tan θ_{T}) of the straight line passing through the edge in each reference line. Namely, the prediction direction may be derived. In this case, the mapping may be expressed in the form of f(x)→f(kx). Finding the value k that minimizes the difference between the two reference lines is equivalent to finding the value k that minimizes ∫|f(kx)−g(x)|dx. For example, in the example of FIG. 12, with f(x) defined as the left reference line and g(x) as the top reference line, k=x/y may be derived according to the method described above.

Alternatively, to reduce computational complexity, the integer-pixel reference line may be mapped, and then the mapped integer-pixel reference line may be approximated to a sub-pixel reference line, as shown in the example of FIG. 13B. By finding a mapping value k that minimizes the difference between the mapped integer-pixel reference line and the sub-pixel reference line, a prediction direction may be derived.

Hereinafter, the derived prediction direction is denoted by implicitAngle. The implicitAngle has the same meaning as intraPredAngle in Table 1. Namely, if implicitAngle=32, which is equivalent to intraPredAngle=32, it corresponds to predModeIntra 2 or 66. Hereafter, the implicitAngle value that points 45 degrees upward (or 45 degrees downward) is referred to as θ_{π/4}. Thus, θ_{π/4} corresponds to intraPredAngle=32 in the prior art.

As shown in Table 1, the implicitAngle value according to the prediction mode (predModeIntra) is symmetric with respect to mode 34 (45 degrees upward to the left), so prediction modes that have the same angle with respect to the direction of mode 34 have the same implicitAngle value. Therefore, prediction modes with the same implicitAngle value may have different prediction modes. To identify their difference, the implicitAngle for directional modes with predModeIntra=34, 35, 36, 37, . . . is called implicitAngleTop, and the implicitAngle for directional modes with predModeIntra=33, 32, 31, 30, . . . is called implicitAngleLeft. In this case, planar mode 0 and DC mode 1 are excluded from implicitAngleTop and implicitAngleLeft.

In the present disclosure, for deriving the prediction direction, the video decoding device first derives the implicitAngleTop and the implicitAngleLeft, and then selects one of them. The implicitAngleTop and implicitAngleLeft may be derived as follows.

First, defined are functions that represent the difference between the top reference line and the left reference line, as shown in Equation 1.

$${f}_{T} ( k ) = {\sum }_{x = 1}^{v H} \vert SPR {L}_{T} [ ( k x + \frac{1}{2} {θ}_{π / 4} ) ≫ {log}_{2} {θ}_{π / 4} ] - S P R {L}_{L} [ ux ] \vert \qquad [ Equation 1 ]$$

$${f}_{L} ( k ) = {\sum }_{x = 1}^{v W} \vert SPR {L}_{T} [ u x ] - S P R {L}_{L} [ ( k x + \frac{1}{2} {θ}_{π / 4} ) ≫ {log}_{2} {θ}_{π / 4} ] \vert$$

Here, f_{T}(k) applies the mapping to the top reference line and then calculates the difference between the mapped top reference line and the left reference line. The left reference line may be a left integer-pixel reference line or a left sub-pixel reference line. Hereinafter, f_{T}(k) is referred to as the top cost function. Further, f_{L}(k) applies the mapping to the left reference line and then calculates the difference between the mapped left reference line and the top reference line. At this time, the top reference line may be the top integer-pixel reference line or the top sub-pixel reference line. Hereinafter, f_{L}(k) is referred to as the left cost function.

Further, when using the method of approximating the integer-pixel to the sub-pixel, u is set as the upscaling factor, and v is set to 1. Additionally, when using the method of approximating the sub-pixel to sub-pixel, u is set to 1 and v is set as the upscaling factor.

Using the cost functions, implicitAngleTop and implicitAngleLeft are calculated as shown in Equation 2.

$$implicitAngleTop = {arg min}_{0 < k \leq {T}_{limit}} {f}_{T} ( k ) \qquad [ Equation 2 ]$$

$$implicitAngleLeft = {arg min}_{0 < k \leq {L}_{limit}} {f}_{L} ( k )$$

implicitAngleTop represents the mapping that minimizes the top cost function and is named the top implicit prediction direction. Additionally, implicitAngleLeft represents the mapping that minimizes the left cost function and is named the left implicit prediction direction.

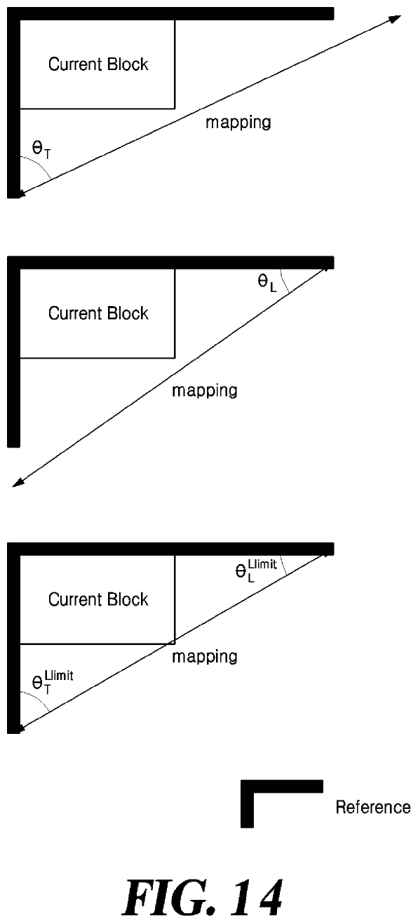

Tₗᵢₘᵢₜ and Lₗᵢₘᵢₜ prevent the range from being exceeded during the approximation process. Namely, if the value of k is too large (i.e., if the value of tan θ_{T} or tan θ_{L} is too large), as in the example of FIG. 14, there may be no reference pixels that are mapped. To avoid this situation, the value k may be limited. Based on the aspect ratio, Tₗᵢₘᵢₜ and Lₗᵢₘᵢₜ are derived as shown in Equation 3, respectively.

$${T}_{limit} = \frac{W}{H} \times {θ}_{π / 4} , {L}_{limit} = \frac{H}{W} \times {θ}_{π / 4} \qquad [ Equation 3 ]$$

For example, if the current block has a width of 8 and a height of 4, Tₗᵢₘᵢₜ=64 and Lₗᵢₘᵢₜ=16. This means that implicitAngleTop may have values up to 64 (mode 72) and implicitAngleLeft may have values up to 16 (mode 8). This range is the same as the range of directional prediction modes that may be signaled in a block with the corresponding aspect ratio when WAIP (wide angle intra prediction) is applied.

The video decoding device may use the derived implicitAngleTop and derived implicitAngleLeft to derive the final prediction direction, implicitAngle, as shown in Equation 4.

$$When \frac{{f}_{T} ( implicitAngleTop )}{H} < \frac{{f}_{L} ( implicitAngleLeft )}{W} , \qquad [ Equation 4 ]$$

$$implicitAngle = implicitAngleTop$$

$$isPredModeTop = 1$$

$$When \frac{{f}_{T} ( i m plicitAngleTop )}{H} \geq \frac{{f}_{L} ( implicitAngleLeft )}{W} ,$$

$$implicitAngle = implicitAngleLeft$$

$$isPredModeTop = 0$$

Since f_{T}(implicitAngleTop) and f_{L}(implicitAngleLeft) are functions that depend on the height and width of the block, respectively, they are normalized before being compared. The result of the comparison between the normalized top cost function value and the normalized left cost function value determines the implicitAngle, as shown in Equation 4. Hereafter, implicitAngle is referred to as implicit prediction direction or prediction direction. In addition, isPredModeTop is a flag that indicates whether the prediction direction is upward. Namely, isPredModeTop being 1 indicates that the prediction direction is upward (modes 34, 35, . . . directions), and isPredModeTop being 0 indicates that the prediction direction is leftward (modes 33, 32, . . . directions). Hereinafter, isPredModeTop is referred to as an upward prediction mode flag.

On the other hand, if no edge exists in the reference line, the prediction direction derived as described above may be meaningless. Therefore, the video decoding device first determines whether an edge exists in the reference line before performing the approximation process described above. If an edge exists in both the top and left reference lines, the video decoding device derives the prediction direction (i.e., performs the approximation process) as described above. On the other hand, if no edge exists on either of the top and left reference lines, the video decoding device does not derive a prediction direction. In this case, the video decoding device sets the prediction mode to DC mode.

The presence or absence of an edge in a reference line may be determined by using various methods. The following describes a method of determining the presence of an edge by using second-order derivatives, i.e., Laplacian values. For example, the position of the top-left pixel of the current block is defined as (0, 0), the value of the reference pixel at position (x, y) as p[x][y], and the width and height of the current block as W and H, respectively. The video decoding device determines the presence or absence of an edge on each reference line as follows.

First, if the condition of Equation 5 is satisfied, it is determined that no edge exists in the top reference line.

$${max}_{0 \leq x \leq 2 W - 2} ( \vert 2 p [ x ] [ - 1 ] - p [ x - 1 ] [ - 1 ] - p [ x + 1 ] [ - 1 ] \vert ) < Threshold \qquad [ Equation 5 ]$$

The condition of Equation 5 refers to the case where the maximum value of the Laplacian values calculated from the pixels on the top reference line is less than a preset threshold.

Further, if the condition of Equation 6 is satisfied, it is determined that no edge exists on the left reference line.

$${max}_{0 \leq y \leq 2 H - 2} ( \vert 2 p [ - 1 ] [ y ] - p [ - 1 ] [ y - 1 ] - p [ - 1 ] [ y + 1 ] \vert ) < Threshold \qquad [ Equation 6 ]$$

The condition in Equation 6 refers to the case where the maximum value of the Laplacian values calculated from the pixels on the left reference line is less than a preset threshold.

Furthermore, if edges are present on both reference lines, but the graphs of the two reference lines have different shapes, the image of the current block is highly probable not to be in the form of a straight line passing through the two edges. In such a case, the video decoding device derives the prediction mode as planar.

According to the present disclosure, if the difference per pixel being approximated is greater than or equal to a preset threshold, it may be determined that an edge exists but the pixel values are different. Namely, if the conditions shown in Equation 7 are satisfied, the prediction mode is set to planar.

$$min ( \frac{{f}_{T} ( implicitAngleTop )}{H} , \frac{{f}_{L} ( implicitAngleLeft )}{W} ) \geq Threshold \qquad [ Equation 7 ]$$

According to Equation 7, if the minimum of the normalized top cost function value and the normalized left cost function value is greater than or equal to a preset threshold, the prediction mode is set to planar. On the other hand, if the minimum of the normalized top cost function value and the normalized left cost function value is less than the preset threshold, implicitAngle and isPredModeTop may be determined according to Equation 4.

The thresholds may be set differently for the above two situations of determining whether an edge exists or not, and finding that an edge does exist but determining that the two reference line graphs have different shapes. For example, each of the thresholds may be set to a preset value as shown in Equation 8.

$$Threshold = K , ( K = 1 , 2 , 3 , … ) \qquad [ Equation 8 ]$$

Alternatively, each of the thresholds may be adaptively set based on the bit-depth of the image, as shown in Equation 9.

$$Threshold = 1 ≪ ( bitDeph - N ) , ( N = 1 , 2 , 3 , … ) \qquad [ Equation 9 ]$$

Alternatively, each of the thresholds may be adaptively set based on the channel. For this purpose, the value K in Equation 8 or the value N in Equation 9 may be set differently depending on the channel.

Hereinafter, for the case of generating a predictor according to implicitAngle and isPredModeTop derived according to the present disclosure, the prediction mode is defined as IMPLICT_INTRA_MODE which is an implicit prediction mode. Therefore, information on the implicit prediction mode includes implicitAngle and isPredModeTop. Against the implicit prediction mode, the prediction modes presented in Table 1 are referred to as explicit prediction mode or prediction mode.

The following describes methods of generating a predictor from IMPLICT_INTRA_MODE and methods of encoding/decoding the prediction mode.

### <Implementation 1> Using the Derived Prediction Direction as it is

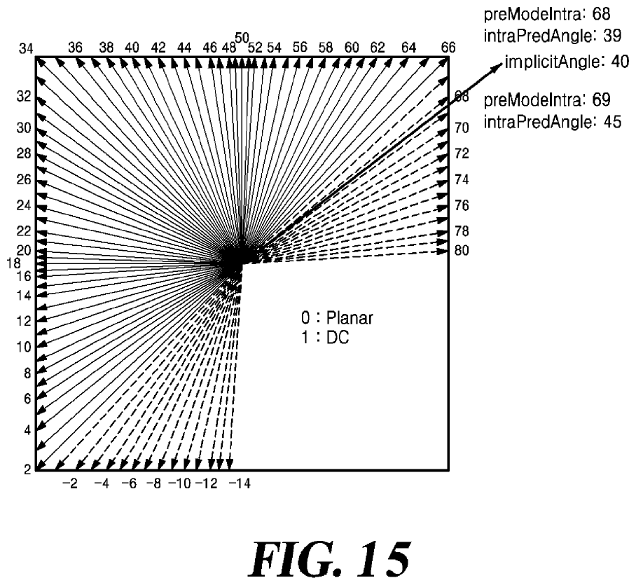

In this implementation, the video decoding device generates a predictor by using the implicitAngle as it is. First, the reference line to use may be selected based on the value of isPredModeTop. Additionally, the value of implicitAngle may be derived as a value that does not correspond to the prediction mode presented in Table 1. The following example describes a case where the implicitAngle value is derived as 40 and isPredModeTop is derived as 1. In Table 1, there is no prediction mode corresponding to the implicitAngle value of 40. In such a case, the video decoding device performs a prediction in the relevant direction even if there is no prediction mode corresponding to the implicitAngle, as shown in the example of FIG. 15.

<Implementation 2> Deriving Prediction Mode from Derived Prediction Direction

In this implementation, the video decoding device derives a prediction mode as shown in Table 1 from the implicitAngle, and then generates a predictor by using the derived prediction mode. Preferred implementations for this purpose are as follows.

### <Implementation 2-1> Deriving One Prediction Mode

In this implementation, the video decoding device derives one prediction mode (PredModeIntra) from the implicitAngle and isPredModeTop. Based on the value of isPredModeTop, the video decoding device finds in Table 1 the intraPredAngle closest to the implicitAngle and sets the prediction mode to PredModeIntra corresponding to the found intraPredAngle. For example, if implicitAngle is 33 and isPredModeTop is 1, the video decoding device finds the closest intraPredAngle 32 in Table 1. Since isPredModeTop is 1, intraPredAngle 32 corresponds to mode 66, not mode 2. Therefore, the prediction mode is set to mode 66. If two closest intraPredAngle values are found, the prediction mode may be set to PredModeIntra which corresponds to the smaller intraPredAngle or the larger intraPredAngle, depending on the implementation.

### <Implementation 2-2> Deriving Multiple Prediction Modes and Selecting One

In this implementation, the video decoding device derives multiple prediction modes (PredModeIntra) from implicitAngle and isPredModeTop. The video decoding device selects one of the multiple prediction modes by using parsed information and generates a predictor based on the selected prediction mode. The video decoding device derives N prediction modes in order of proximity to the implicitAngle based on the value of isPredModeTop, and selects one of the derived N prediction modes by using the parsed information. At this time, N may be set to 2, 3, 4, . . . , etc. depending on the implementation.

Further, as information indicating one of the N prediction modes, an implicit prediction mode index, implicitAngularModeldx, may be signaled from the video encoding device to the video decoding device. The following example describes the case where implicitAngle is 44 and isPredModeTop=1. When deriving three prediction modes by referring to Table 1, prediction modes 69, 68, and 70 are derived in order of proximity. If prediction mode 69 is selected, implicitAngularModeIdx may be signaled as 0.

### <Implementation 3> Method of Signaling a Flag Indicating Whether an Implicit Prediction Mode is to be Derived

The following describes a method of signaling implicit_intra_prediction_flag, a flag indicating whether an implicit prediction mode is to be derived (named as an ‘implicit prediction mode flag’).

Depending on the signaling of the implicit_intra_prediction_flag, the applicability of the present disclosure may be determined. If implicit_intra_prediction_flag is 1, the video decoding device applies the present disclosure to perform the intra prediction. On the other hand, if the implicit_intra_prediction_flag is 0, the video decoding device performs the intra prediction according to a conventional method. In this case, when applying the method of Implementation 2, after the implicit_intra_prediction_flag is signaled, the implicitAngularModeIdx is signaled when the implicit_intra_prediction_flag is 1.

According to the prior art, there is a limitation that intra_luma_ref_idx may have a non-zero value when the prediction mode is included in the MPM list. However, in this implementation, by first signaling the value of intra_luma_ref_idx before the derivation of implicitAngle, the MRL technique may be applied to all prediction modes being derived. If intra_luma_ref_idx is non-zero, the present disclosure may be applied equally by using the relevant reference line. For example, if intra_luma_ref_idx=1, SPRL_{T}[0] and SPRL_{L}[0] are the reference pixels at position (−2, −2) when the top-left pixel of the current block is positioned at (0, 0).

If implicit_intra_prediction_flag is 1, the ISP technique is also applicable, but as with the prior art, ISP mode is not applied if intra_luma_ref_idx is non-zero. If implicit_intra_prediction_flag is 1, then depending on the implementation, intra_luma_ref_idx may not be signaled and a fixed value may be used. In this case, the fixed value may be intra_luma_ref_idx 0. Additionally, if implicit_intra_prediction_flag is 1, neither of intra_subpartitions_mode_flag and intra_subpartitions_split_flag may be signaled without applying the ISP technique.

The following describes a method of decoding (or encoding) the implicit_intra_prediction_flag when the decoding (or encoding) of the intra-prediction mode is performed, as shown in Table 4. As described above, embodiments of the present disclosure are described centered on the video decoding device, but the embodiments may be similarly applied to the video encoding device.

The implicit_intra_prediction_flag may be decoded in both the luma channel and the chroma channel, and may be decoded in different orders to account for different syntaxes. In the following, described are five methods for decoding the implicit_intra_prediction_flag for the luma channel and three methods for the chroma channel. Hereinafter, implicit_intra_prediction( ) denotes a function for performing the intra prediction according to the present disclosure. Implementation 3-1 to Implementation 3-5 are decoding methods in the luma channel, and Implementation 3-6 to Implementation 3-8 are decoding methods in the chroma channel.

In addition, when the MPM list is composed, if the prediction mode of a neighboring block is IMPLICT_INTRA_MODE, the prediction mode of the neighboring block is considered to be planar.

Furthermore, when the prediction mode of the chroma channel is encoded/decoded, if the prediction mode of the chroma channel is DM and the prediction mode of the corresponding luma channel is IMPLICT_INTRA_MODE, the prediction mode of the chroma channel is also set to IMPLICT_INTRA_MODE.

### <Implementation 3-1> Decoding Implicit Prediction Mode Flag First

In this implementation, the video decoding device decodes the implicit_intra_prediction_flag first. Accordingly, the cost of transmitting the prediction mode may be reduced to the lowest possible value. The syntax configuration according to this implementation is shown in Table 6.

```
TABLE 6
implicit_intra_prediction_flag
if(implicit_intra_prediction_flag) {
    if( sps_mrl_enabled_flag && ( ( y0 % CtbSizeY ) > 0 ) )
      intra_luma_ref_idx
  if( sps_isp_enabled_flag && intra_luma_ref_idx = = 0 &&
    ( cbWidth <= MaxTbSizeY && cbHeight <= MaxTbSizeY ) &&
    ( cbWidth * cbHeight > MinTbSizeY * MinTbSizeY ) &&
    !cu_act_enabled_flag )
      intra_subpartitions_mode_flag
    if( intra_subpartitions_mode_flag = = 1 )
      intra_subpartitions_split_flag
    implicit_intra_prediction( )
} else {
    if( sps_mip_enabled_flag )
      intra_mip_flag
    . . .
    }
}
```

<Implementation 3-2> after Decoding MIP Mode Information, Decoding Implicit Prediction Mode Flag

In this implementation, the video decoding device decodes the implicit_intra_prediction_flag after decoding the MIP mode information and before decoding the MRL information. The syntax configuration according to this implementation is shown in Table 7.

```
TABLE 7
if( sps_mip_enabled_flag )
  intra_mip_flag
if( intra_mip_flag ) {
  intra_mip_transposed_flag[ x0 ][ y0 ]
  intra_mip_mode[ x0 ][ y0 ]
} else {
  implicit_intra_prediction_flag
  if(implicit_intra_prediction_flag) {
      if( sps_mrl_enabled_flag && ( ( y0 % CtbSizeY ) > 0 ) )
        intra_luma_ref_idx
  if( sps_isp_enabled_flag && intra_luma_ref_idx = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
        intra_subpartitions_mode_flag
      if( intra_subpartitions_mode_flag = = 1 )
        intra_subpartitions_split_flag
      implicit_intra_prediction( )
  } else {
      if( sps_mrl_enabled_flag && ( ( y0 % CtbSizeY ) > 0 ) )
        intra_luma_ref_idx
      . . .
  }
}
```

<Implementation 3-3> after Decoding MRL Information, Decoding Implicit Prediction Mode Flag

In this implementation, the video decoding device decodes the implicit_intra_prediction_flag after decoding the MRL information and before decoding the ISP mode information. The syntax configuration according to this implementation is shown in Table 8.

```
TABLE 8
if( sps_mip_enabled_flag )
  intra_mip_flag
if( intra_mip_flag ) {
  intra_mip_transposed_flag[ x0 ][ y0 ]
  intra_mip_mode[ x0 ][ y0 ]
} else {
  if( sps_mrl_enabled_flag && ( ( y0 % CtbSizeY ) > 0 ) )
    intra_luma_ref_idx
  implicit_intra_prediction_flag
  if(implicit_intra_prediction_flag) {
    if( sps_isp_enabled_flag && intra_luma_ref_idx = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
          intra_subpartitions_mode_flag
      if( intra_subpartitions_mode_flag = = 1 )
          intra_subpartitions_split_flag
      implicit_intra_prediction( )
  } else {
    if( sps_isp_enabled_flag && intra_luma_ref_idx = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
        intra_subpartitions_mode_flag
    . . .
  }
}
```

<Implementation 3-4> after Decoding ISP Mode Information, Decoding Implicit Prediction Mode Flag

In this implementation, the video decoding device decodes the implicit_intra_prediction_flag after decoding the ISP mode information and before decoding the MPM information. The syntax configuration according to this implementation is shown in Table 9.

```
TABLE 9
if( sps_mip_enabled_flag )
  intra_mip_flag
if( intra_mip_flag ) {
  intra_mip_transposed_flag[ x0 ][ y0 ]
  intra_mip_mode[ x0 ][ y0 ]
} else {
  if( sps_mrl_enabled_flag && ( ( y0 % CtbSizeY ) > 0 ) )
    intra_luma_ref_idx
  if( sps_isp_enabled_flag && intra_luma_ref_idx = = 0 &&
    ( cbWidth <= MaxTbSizeY && cbHeight <= MaxTbSizeY ) &&
    ( cbWidth * cbHeight > MinTbSizeY * MinTbSizeY ) &&
    !cu_act_enabled_flag )
    intra_subpartitions_mode_flag
  if( intra_subpartitions_mode_flag = = 1 )
    intra_subpartitions_split_flag
  implicit_intra_prediction_flag
  if(implicit_intra_prediction_flag)
      implicit_intra_prediction( )
  else {
    if( intra_luma_ref_idx = = 0 )
        intra_luma_mpm_flag[ x0 ][ y0 ]
    . . .
  }
}
```

### <Implementation 3-5> Decoding Implicit Prediction Mode Flag Before MPM Remainder

In this implementation, the video decoding device decodes the implicit_intra_prediction_flag before the MPM remainder. The syntax configuration according to this implementation is shown in Table 10.

TABLE 10

```
if( sps_mip_enabled_flag )
  intra_mip_flag
if( intra_mip_flag ) {
  intra_mip_transposed_flag[ x0 ][ y0 ]
  intra_mip_mode[ x0 ][ y0 ]
} else {
  . . .
  if( intra_luma_ref_idx = = 0 )
    intra_luma_mpm_flag[ x0 ][ y0 ]
  if( intra_luma_mpm_flag[ x0 ][ y0 ] ) {
    if( intra_luma_ref_idx = = 0 )
        intra_luma_not_planar_flag[ x0 ][ y0 ]
    if( intra_luma_not_planar_flag[ x0 ][ y0 ] )
        intra_luma_mpm_idx[ x0 ][ y0 ]
  } else {
      implicit_intra_prediction_flag
      if(implicit_intra_prediction_flag)
        implicit_intra_prediction( )
      else
        intra_luma_mpm_remainder[ x0 ][ y0 ]
}
```

### <Implementation 3-6> Decoding Implicit Prediction Mode Flag First for Chroma Channel

In this implementation, the video decoding device decodes the implicit_intra_prediction_flag first for the chroma channel.

Meanwhile, in encoding/decoding the intra-prediction mode of the chroma channel, the DM (derived mode) is indicated as intra_chroma_pred_mode. As described above, if the prediction mode of the chroma channel is DM and the prediction mode of the corresponding luma channel of the chroma channel is IMPLICT_INTRA_MODE, it is equivalent to the prediction mode of the chroma channel being IMPLICT_INTRA_MODE. Therefore, if the information on implicit_intra_prediction_flag is decoded first and the prediction mode of the corresponding luma channel is IMPLICT_INTRA_MODE, the intra_chroma_pred_mode may be encoded/decoded with the value corresponding to DM removed. In other words, according to the prior art, the encoding/decoding of the intra_chroma_pred_mode is performed as shown in Table 11, whereas this implementation performs the encoding/decoding with the value corresponding to DM removed as shown in Table 12, thereby increasing the coding efficiency.

TABLE 11

| Value of intra_chroma_pred_mode | Bin string |
|---|---|
| 0 | 100 |
| 1 | 101 |
| 2 | 110 |
| 3 | 111 |
| 4 | 0 |

TABLE 12

| Value of intra_chroma_pred_mode | Bin string |
|---|---|
| 0 | 00 |
| 1 | 01 |
| 2 | 10 |
| 3 | 11 |

The syntax configuration according to this implementation is shown in Table 13.

TABLE 13

```
implicit_intra_prediction_flag
if(implicit_intra_prediction_flag)
  implicit_intra_prediction( )
else {
  if( cclmEnabled )
    cclm_mode_flag
  if( cclm_mode_flag )
    cclm_mode_idx
  else
    intra_chroma_pred_mode
}
```

<Implementation 3-7> Decoding Implicit Prediction Mode Flag after Decoding CCLM Mode Information

In this implementation, the video decoding device decodes the CCLM mode information for the chroma channel and then decodes the implicit_intra_prediction_flag. If the prediction mode of the corresponding luma channel is IMPLICT_INTRA_MODE, the video decoding device may decode intra_chroma_pred_mode with the value corresponding to DM removed. This is the same as described in Implementation 3-6. The syntax configuration according to this implementation is shown in Table 14.

TABLE 14

```
if( cclmEnabled )
  cclm_mode_flag
if( cclm_mode_flag )
  cclm_mode_idx
else {
  implicit_intra_prediction_flag
  if(implicit_intra_prediction_flag)
      implicit_intra_prediction( )
  else
    intra_chroma_pred_mode
}
```

<Implementation 3-8> Indicating IMPLICIT_INTRA_MODE with intra_chroma_pred_mode

In this implementation, the video decoding device is responsive to the prediction mode of the chroma channel being IMPLICT_INTRA_MODE for indicating the prediction mode of the chroma channel by using intra_chroma_pred_mode. For example, an intra_chroma_pred_mode of 5 indicates that the prediction mode is IMPLICT_INTRA_MODE. For coding efficiency of prediction modes, the shortest bin strings are allocated to DM and IMPLICT_INTRA_MODE as shown in Table 15, and the remaining prediction modes may be allocated with the same bin strings as in the prior art.

TABLE 15

| Value of intra_chroma_pred_mode | Bin string |
|---|---|
| 0 | 100 |
| 1 | 101 |
| 2 | 110 |
| 3 | 111 |
| 4 | 00 |
| 5 | 01 |

The syntax configuration according to this implementation is shown in Table 16.

TABLE 16

```
if( cclmEnabled )
  cclm_mode_flag
if( cclm_mode_flag )
  cclm_mode_idx
else {
  intra_chroma_pred_mode
}
```

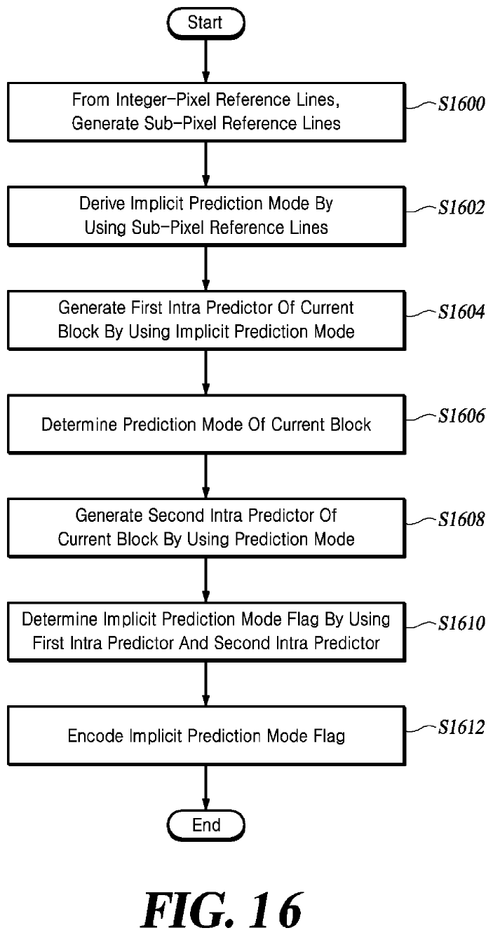

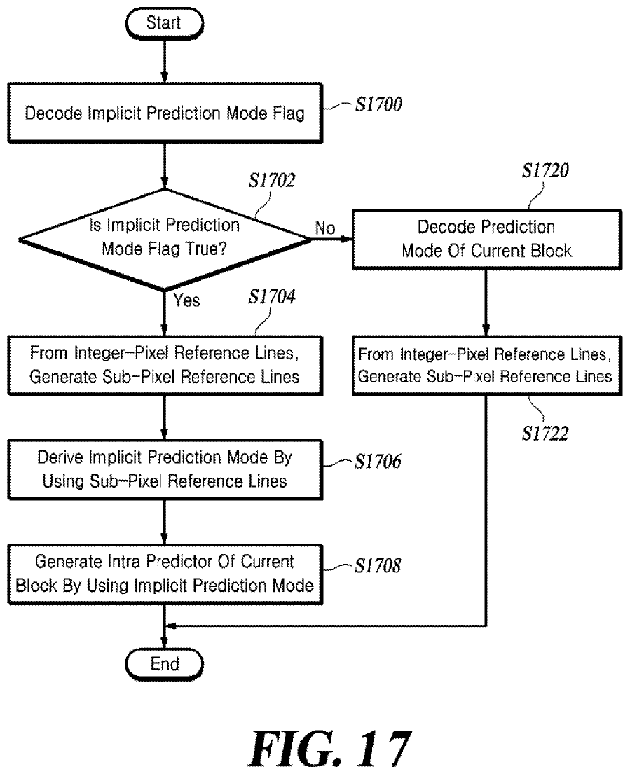

Referring now to FIGS. 16 and 17, methods of intra-predicting of the current block based on a derived implicit prediction mode will be described.

FIG. 16 is a flowchart of a method performed by the video encoding device for intra-predicting the current block, according to at least one embodiment of the present disclosure.

The video encoding device obtains sub-pixel reference lines from the integer-pixel reference lines of the current block (S1600). Here, the integer-pixel reference lines include a top integer-pixel reference line and a left integer-pixel reference line. Further, the sub-pixel reference lines include a top sub-pixel reference line and a left sub-pixel reference line.

The video encoding device derives an implicit prediction mode by using the sub-pixel reference lines (S1602). Here, the information on the implicit prediction mode IMPLICT_INTRA_MODE includes a prediction direction implicitAngle and an upward prediction mode flag isPredModeTop, and the upward prediction mode flag indicates whether the prediction direction is upward.

After applying the mapping k to the top integer-pixel reference line or the top sub-pixel reference line, the video encoding device calculates a value of a top cost function f_{T}(k) representing the difference between the mapped top reference line and the left reference line. Here, the left reference line represents the left integer-pixel reference line or the left sub-pixel reference line. The video encoding device derives a mapping value that minimizes the value of the above top cost function, as the top implicit prediction direction implicitAngleTop.

The left reference line indicates the left integer-pixel reference line or the left sub-pixel reference line, and the top reference line indicates the top integer-pixel reference line or the top sub-pixel reference line.

Further, after applying the mapping k to the left integer-pixel reference line or left sub-pixel reference line, the video encoding device calculates a value of a left cost function f_{L}(k) representing the difference between the mapped left reference line and the top reference line. Here, the top reference line represents the top integer-pixel reference line or the top sub-pixel reference line. The video encoding device derives a mapping value that minimizes the value of the left cost function, as the left implicit prediction direction implicitAngleLeft.

Meanwhile, the range of the above-described mapping may be determined based on the aspect ratio of the current block.

The video encoding device may normalize the value f_{T}(implicitAngleTop) of the top cost function, calculated from the top implicit prediction direction based on the height of the current block. Further, the video encoding device normalizes the value f_{L}(implicitAngleLeft) of the left cost function, calculated from the left implicit prediction direction based on the width of the current block. Based on the comparison result between the normalized top cost function value and the normalized left cost function value, the video encoding device determines the prediction direction implicitAngle and the upward prediction mode flag isPredModeTop as information on the implicit prediction mode by using the top implicit prediction direction and the left implicit prediction direction.

Further, the video encoding device checks whether the graphs of the two reference lines have different shapes. For example, the video encoding device sets the prediction mode of the current block to planar mode if the minimum value of the normalized top cost function value and the normalized left cost function value is greater than or equal to a predetermined threshold. Accordingly, if the minimum value of the normalized top cost function value and the normalized left cost function value is less than the predetermined threshold, the video encoding device may determine the information on the implicit prediction mode.

Further, the video encoding device may determine whether an edge exists in the integer-pixel reference lines. For example, the video encoding device may determine the presence or absence of an edge by using second-order derivatives, i.e., Laplacian values. If an edge exists in both the top integer-pixel reference line and the left integer-pixel reference line, the video encoding device derives the implicit prediction mode as described above. On the other hand, if no edge exists in either the top integer-pixel reference line or the left integer-pixel reference line, the video encoding device does not derive an implicit prediction mode, and sets the prediction mode of the current block to DC mode.

The video encoding device generates the first intra-predictor of the current block by using the integer-pixel reference lines and the implicit prediction mode (S1604).

The video encoding device may utilize the implicit prediction mode as it is to generate the predictor of the current block.

Alternatively, the video encoding device may refer to the upward prediction mode flag to set the prediction mode of the current block to a prediction mode that is closest to the prediction direction of the implicit prediction mode. The video encoding device may then generate a predictor of the current block by using the set prediction mode.

Alternatively, the video encoding device may refer to the upward prediction mode flag to derive a predetermined number of prediction modes in order of proximity to the prediction direction of the implicit prediction mode. In terms of optimizing rate distortion, the video encoding device may select one of the derived prediction modes as the prediction mode of the current block. Thereafter, the video encoding device may generate a predictor of the current block by using the selected prediction mode. Further, the video encoding device encodes an implicit prediction mode index, implicitAngularModeIdx indicative of the selected one of the derived prediction modes.

The video encoding device determines a prediction mode of the current block (S1606).

Here, the prediction mode may be the prediction mode according to FIG. 3B. Alternatively, the prediction mode may be a prediction mode according to an MIP, ISP, or the like.

The video encoding device generates a second intra-predictor of the current block by using the reference lines and the prediction mode (S1608).

The video encoding device determines an implicit prediction mode flag by using the first intra-predictor and the second intra-predictor (S1610).

Here, the implicit prediction mode flag, implicit_intra_prediction_flag indicates whether the implicit prediction mode is to be derived. For example, the video encoding device may generate the optimal predictor between the first intra-predictor and the second intra-predictor in terms of optimizing distortion against the current block. When the optimal predictor is the first intra-predictor, the video encoding device may set the implicit prediction mode flag to true. On the other hand, when the optimal predictor is the second intra-predictor, the video encoding device may set the implicit prediction mode flag to false.

The video encoding device encodes the implicit prediction mode flag (S1612).

FIG. 17 is a flowchart of a method performed by the video decoding device for intra-predicting the current block, according to at least one embodiment of the present disclosure.

The video decoding device decodes an implicit prediction mode flag (S1700).

The video decoding device checks the value of the implicit prediction mode flag (S1702).

If the implicit prediction mode flag, implicit_intra_prediction_flag is true (Yes in S1702), the video decoding device performs the following steps (S1704 to S1708).

The video decoding device generates sub-pixel reference lines from integer-pixel reference lines (S1704). Here, the integer-pixel reference lines include a top integer-pixel reference line and a left integer-pixel reference line. Further, the sub-pixel reference lines include a top sub-pixel reference line and a left sub-pixel reference line.

The video decoding device derives an implicit prediction mode by using the sub-pixel reference lines (S1706). Here, the information on the implicit prediction mode, IMPLICT_INTRA_MODE includes the prediction direction of implicitAngle and the upward prediction mode flag of isPredModeTop, and the upward prediction mode flag indicates whether the prediction direction is upward.

The video decoding device may derive the implicit prediction mode in the same way as the video encoding device, and so no further description is provided.

The video decoding device generates an intra-predictor for the current block by using the integer-pixel reference lines and the implicit prediction mode (S1708).

The video decoding device may utilize the implicit prediction mode as it is to generate the predictor of the current block.

Alternatively, the video decoding device may refer to the upward prediction mode flag to set the prediction mode of the current block to a prediction mode that is closest to the prediction direction of the implicit prediction mode. The video decoding device may then generate the predictor of the current block by using the set prediction mode.

Alternatively, the video decoding device may decode the implicit prediction mode index, implicitAngularModeIdx. The video decoding device references the upward prediction mode flag to derive a predetermined number of prediction modes in order of proximity to the prediction direction of the implicit prediction mode. The video encoding device may select one of the prediction modes derived by using the implicit prediction mode index as the prediction mode of the current block. Then, the video decoding device may generate the predictor of the current block by using the selected prediction mode.

On the other hand, if the implicit prediction mode flag is false (No in S1702), the video decoding device performs the following steps (S1720 and S1722).

The video decoding device decodes the prediction mode of the current block (S1720). Here, the prediction mode may be the prediction mode according to FIG. 3B. Alternatively, the prediction mode may be a prediction mode according to an MIP, ISP, or the like.

The video decoding device generates an intra-predictor of the current block by using the integer-pixel reference lines and the prediction mode (S1722).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor

### CROSS-REFERENCE TO RELATED APPLICATIONS

This application claims priority to and the benefit of Korean Patent Application No. 10-2022-0058185 filed on May 12, 2022, and Korean Patent Application No. 10-2023-0048825, filed on Apr. 13, 2023, the entire contents of each of which are incorporated herein by reference.

1. A method performed by a video decoding device for intra-predicting a current block, the method comprising:
generating sub-pixel reference lines that include a top sub-pixel reference line and a left sub-pixel reference line from integer-pixel reference lines that belong to the current block and include a top integer-pixel reference line and a left integer-pixel reference line;
deriving an implicit prediction mode by using the sub-pixel reference lines, wherein information on the implicit prediction mode includes a prediction direction and an upward prediction mode flag that indicates whether the prediction direction is upward; and
generating an intra-predictor of the current block by using the integer-pixel reference lines and the implicit prediction mode.

2. The method of claim 1, further comprising:
decoding an implicit prediction mode flag that indicates whether the implicit prediction mode is to be derived; and
checking a value of the implicit prediction mode flag;
wherein when the implicit prediction mode flag is true, the method further comprises:
deriving the implicit prediction mode.

3. The method of claim 1, wherein deriving the implicit prediction mode comprises:
applying a mapping to the top integer-pixel reference line or the top sub-pixel reference line, calculating a value of a top cost function representing a difference between a top reference line that is mapped and a left reference line, and deriving a mapping value that minimizes the value of the top cost function, as a top implicit prediction direction; and
applying the mapping to the left integer-pixel reference line or the left sub-pixel reference line, calculating a value of a left cost function representing a difference between the left reference line that is mapped and the top reference line, and deriving a mapping value that minimizes the value of the left cost function, as a left implicit prediction direction;
wherein the top reference line represents the top integer-pixel reference line or the top sub-pixel reference line, and the left reference line represents the left integer-pixel reference line or the left sub-pixel reference line.

4. The method of claim 3, wherein deriving the implicit prediction mode comprises:
normalizing the value of the top cost function calculated in the top implicit prediction direction based on a height of the current block, and normalizing the value of the left cost function calculated in the left implicit prediction direction based on a width of the current block, and
wherein when a minimum value between a normalized value of the top cost function and a normalized value of the left cost function is less than a predetermined threshold, the method further comprises:
determining the prediction direction and the upward prediction mode flag by using the top implicit prediction direction and the left implicit prediction direction.

5. The method of claim 4, further comprising:
when the minimum value between the normalized value of the top cost function and the normalized value of the left cost function is greater than or equal to the predetermined threshold, setting a prediction mode of the current block to planar mode.

6. The method of claim 3, further comprising:
determining an range of the mapping based on an aspect ratio of the current block.

7. The method of claim 1, further comprising:
determining whether an edge is present in or absent from the integer-pixel reference lines,
wherein when the edge is present in both the top integer-pixel reference line and the left integer-pixel reference line, the method further comprises:
deriving the implicit prediction mode.

8. The method of claim 7, further comprising:
when the edge is absent from both the top integer-pixel reference line and the left integer-pixel reference line, aborting the deriving of the implicit prediction mode, and setting a prediction mode of the current block to DC mode.

9. The method of claim 1, wherein generating the intra-predictor of the current block comprises:
deriving a prediction mode of the current block from the implicit prediction mode; and
generating the intra-predictor by using the prediction mode.

10. The method of claim 9, wherein deriving the prediction mode of the current block comprises:
setting the prediction mode of the current block to the prediction direction of the implicit prediction mode by referring to the upward prediction mode flag.

11. The method of claim 9, wherein deriving the prediction mode of the current block comprises:
setting the prediction mode of the current block to a prediction mode closest to the prediction direction of the implicit prediction mode by referring to the upward prediction mode flag.

12. The method of claim 9, wherein deriving the prediction mode of the current block comprises:
decoding an implicit prediction mode index;
deriving a predetermined number of prediction modes in an order of proximity to the prediction direction of the implicit prediction mode by referring to the upward prediction mode flag; and
selecting one of derived prediction modes as the prediction mode of the current block by using the implicit prediction mode index.

13. A method performed by a video encoding device for intra-predicting a current block, the method comprising:
generating sub-pixel reference lines that include a top sub-pixel reference line and a left sub-pixel reference line from integer-pixel reference lines that belong to the current block and include a top integer-pixel reference line and a left integer-pixel reference line;
deriving an implicit prediction mode by using the sub-pixel reference lines, wherein information on the implicit prediction mode includes a prediction direction and an upward prediction mode flag that indicates whether the prediction direction is upward; and
generating a first intra-predictor of the current block by using the integer-pixel reference lines and the implicit prediction mode.

14. The method of claim 13, further comprising:
determining a prediction mode of the current block;
generating a second intra-predictor of the current block by using the integer-pixel reference lines and the prediction mode.

15. The method of claim 14, further comprising:
determining, by using the first intra-predictor and the second intra-predictor, an implicit prediction mode flag that indicates whether the implicit prediction mode is to be derived; and
encoding the implicit prediction mode flag.

16. A computer-readable recording medium storing a bitstream generated by a video encoding method, the video encoding method comprising:
generating sub-pixel reference lines that include a top sub-pixel reference line and a left sub-pixel reference line from integer-pixel reference lines that belong to a current block and include a top integer-pixel reference line and a left integer-pixel reference line;
deriving an implicit prediction mode by using the sub-pixel reference lines, wherein information on the implicit prediction mode includes a prediction direction and an upward prediction mode flag that indicates whether the prediction direction is upward; and
generating an intra-predictor of the current block by using the integer-pixel reference lines and the implicit prediction mode.
